(19) United States
(12) Patent Application Publication
(10) Pub. No.: US 2006/0262157 A1
(43) Pub. Date: Nov. 23, 2006

(54) Method of manufacturing inkjet printhead using crosslinked polymer

(76) Inventors: Byung-ha Park, Suwon-si (KR); Young-ung Ha, Suwon-si (KR); Sung-joon Park, Suwon-si (KR); Jae-sik Min, Suwon-si (KR); Kyong-il Kim, Seoul (KR)

Correspondence Address: STANZIONE & KIM, LLP, 919 18TH STREET, N.W., SUITE 440, WASHINGTON, DC, 20006, US

(21) Appl. No.: 11/415,198

(22) Filed: May 2, 2006

(30) Foreign Application Priority Data
May 12, 2005 (KR) 2005-39712

(51) Int. Cl. B41J 2/015; G01D 15/00

(52) U.S. Cl. 347/20; 216/27

(57) ABSTRACT

A method of manufacturing an inkjet printhead includes preparing a substrate having a heater to hear ink and an electrode to supply current to the heater, applying a crosslinked polymer resist composition to the substrate having the heater and the electrode and patterning the same, and forming a passage forming layer that surrounds an ink passage, patterning the substrate having the passage forming layer by photolithography at least twice, and forming a sacrificial layer having a planarized top surface in a space surrounded by the passage forming layer, applying the crosslinked polymer resist composition to the passage forming layer and the sacrificial layer and patterning the same, and forming a nozzle layer having a nozzle, etching the substrate from the bottom surface thereof to be perforated, and forming an ink supply hole, and removing the sacrificial layer, wherein the crosslinked polymer resist composition comprises a precursor polymer that is a phenolic novolak resin having glycidyl ether functional groups on repeating monomer units.

### CROSS-REFERENCE TO RELATED APPLICATIONS

This application claims priority under 35 U.S.C. §119(a) from Korean Patent Application No. 2005-39712, filed on May 12, 2005, in the Korean Intellectual Property Office, the disclosure of which is incorporated herein in its entirety by reference.

### BACKGROUND OF THE INVENTION

1. Field of the Invention

The present general inventive concept relates to a method of manufacturing an inkjet printhead, and more particularly, to a method of manufacturing an inkjet resist composition printhead by photolithography using a crosslinked polymer.

2. Description of the Related Art

In general, inkjet printheads are devices for printing a predetermined color image by ejecting small droplets of printing ink at a desired position on a recording sheet. Ink ejection mechanisms of an inkjet printer are generally categorized into two different types: a thermally driven type (bubble-jet type), in which a heat source is employed to form bubbles in ink thereby causing an ink droplet to be ejected, and an piezoelectrically driven type, in which an ink droplet is ejected by a change in ink volume due to deformation of a piezoelectric element.

A typical structure of a conventional thermally-driven inkjet printhead is illustrated in FIG. 1. Referring to FIG. 1, the inkjet printhead includes a substrate 10, a passage forming layer 20 stacked on the substrate 10, and a nozzle plate 30 formed on the passage plate 20. An ink supply hole 51 is formed in the substrate 10. The passage forming layer 20 has an ink chamber 53 to store ink and a restrictor 52 connecting the ink supply hole 51 and the ink chamber 53. The nozzle layer 30 has a nozzle 54 through which the ink is ejected from the ink chamber 53. Also, the substrate 10 has a heater 41 for heating ink in the ink chamber 53 and an electrode 42 for supplying current to the heater 41.

The ink ejection mechanism of the conventional thermally-driven inkjet printhead having the above-described configuration will now be described. Ink is supplied from an ink reservoir (not illustrated) to the ink chamber 53 through the ink supply hole 51 and the restrictor 52. The ink filling the ink chamber 53 is heated by a heater 41 consisting of resistive heating elements. The ink boils to form bubbles and the bubbles expand so that the ink in the ink chamber 53 is ejected by a bubble pressure. Accordingly, the ink in the ink chamber 53 is ejected outside the ink chamber 53 through the nozzle 54 in the form of ink droplets.

The conventional thermally-driven inkjet printhead having the above-described configuration can be monolithically manufactured by photolithography, and the photolithography manufacturing process thereof is illustrated in FIGS. 2A through 2E.

Referring to FIG. 2A, a substrate 10 having a predetermined thickness is prepared, and a heater 41 for heating ink and an electrode 42 for supplying a current to the heater 41 are formed on the substrate 10.

As illustrated in FIG. 2B, a negative type photoresist composition is applied to the entire surface of the substrate 10 to a predetermined thickness and the negative type photoresist composition is then patterned in such a shape as to surround an ink chamber 53 (see FIG. 2E) and a restrictor 52 (see FIG. 2E) by photolithography, thereby forming a passage forming layer 20.

As illustrated in FIG. 2C, a space surrounded by the passage forming layer 20 is filled with a positive-type photoresist composition, thereby forming a sacrificial layer S. In detail, the positive-type photoresist composition is applied to the entire surface of the substrate 10 to a predetermined thickness and the positive-type photoresist composition is then patterned, thereby forming a sacrificial layer S. Here, the positive-type photoresist composition is generally applied by spin coating, and the top surface of the applied positive-type photoresist is not planarized (i.e., has an uneven surface, as illustrated in FIGS. 2C and 2D) due to the centrifugal force of the spin coating. In other words, the positive-type photoresist bulges upward around the passage forming layer 20 due to the centrifugal force provided during spin coating, as indicated by the double-dashed line illustrated in FIG. 2C. If the uneven surface of the positive-type photoresist is patterned, the sacrificial layer S protrudes upward at its peripheral edges, as illustrated in FIG. 2D.

As illustrated in FIG. 2D, a negative type photoresist composition is applied to the passage forming layer 20 and the sacrificial layer S to a predetermined thickness and the negative type photoresist composition is then patterned by photolithography, thereby forming a nozzle layer 30 having a nozzle 54.

Subsequently, as illustrated in FIG. 2E, the bottom surface of the substrate 10 is wet-etched to form an ink supply hole 51, and the sacrificial layer S is removed through the ink supply hole 51, thereby forming the restrictor 52 and the ink chamber 53 in the passage forming layer 20.

Referring back to FIG. 2D, when forming the nozzle layer 30 by applying a crosslinked polymer resist composition to the sacrificial layer S, a projecting edge of the sacrificial layer S made of the positive-type photoresist may react with a solvent contained in the crosslinked polymer resist composition, causing deformation or melting. Then, as illustrated in FIG. 2E, a cavity C is formed between the passage forming layer 20 and the nozzle layer 30. Furthermore, the passage forming layer 20 and the nozzle layer 30 are not suitably adhered to each other due to existence of the cavity C formed between the passage forming layer 20 and the nozzle layer 30.

As described above, according to the conventional manufacturing method of an inkjet printhead, since the shape and dimension of an ink passage are not easily controlled, it is difficult to attain uniformity of the ink passage, and an ink ejection performance of the printhead may deteriorate. Further, since the passage forming layer 20 and the nozzle layer 30 are not suitably adhered to each other, the durability of the inkjet printhead is lowered.

Referring back to FIG. 2D, the crosslinked polymer resist composition applied to the sacrificial layer S is patterned by exposure, development, and baking. During the exposure, broadband UV light, including I-line (353 nm), H-line (405 nm), and G-line (436 nm), is usually used. Here, the H-line and the G-line, each having a relatively long wavelength and a long penetration depth, affect both the crosslinked polymer resist composition forming the nozzle layer 30 and the positive photoresist forming the sacrificial layer S disposed under the nozzle layer 30. Also, when the positive photoresist is irradiated with UV light, a photosensitizer contained therein may be decomposed by the light, producing nitrogen (N₂) gas. The produced nitrogen gas expands during baking to lift the nozzle layer 30, resulting in deformation of the nozzle layer 30.

### SUMMARY OF THE INVENTION

The present general inventive concept provides a method of manufacturing an inkjet printhead that can easily control a shape and dimension of an ink passage by planarizing a top surface of a sacrificial layer, thereby improving uniformity of the ink passage, and an inkjet printhead manufactured by the method.

The present general inventive concept provides an inkjet printhead having a planarized surface of a sacrificial layer to control a shape and a dimension of an ink passage, thereby improving uniformity of the ink passage and preventing deformation of a nozzle layer due to gas generated in the sacrificial layer.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of manufacturing an inkjet printhead, the method including preparing a substrate having a heater to heat ink and an electrode to supply current to the heater, applying a crosslinkable polymer resist composition to the substrate having the heater and the electrode and patterning the crosslinkable polymer resist composition to form a passage forming layer that surrounds an ink passage, patterning the substrate having the passage forming layer by photolithography at least twice, and forming a sacrificial layer having a planarized top surface in a space surrounded by the passage forming layer, applying the crosslinkable polymer resist composition to the passage forming layer and the sacrificial layer and patterning the crosslinkable polymer resist composition to form a nozzle layer having a nozzle, etching a bottom surface of the substrate to form an ink supply hole, and removing the sacrificial layer, wherein the crosslinkable polymer resist composition comprises a precursor polymer that is a phenolic novolak resin having glycidyl ether functional groups on repeating monomer units thereof.

The monomers in the precursor polymer can all have an identical formula. The monomers in the precursor polymer can all have different formulas. The monomers in the precursor polymer can include a mixture of some of the monomers having an identical formula and others of the monomers having different formulas.

The foregoing and/or other aspects and utilities of the present general inventive concept may also be achieved by providing an inkjet printhead manufactured by the method.

The foregoing and/or other aspects and utilities of the present general inventive concept may also be achieved by providing a method of making an inkjet print head, including applying a first crosslinked polymer resist composition to a substrate having a heater and an electrode, patterning the first crosslinked polymer resist composition to form a passage forming layer that surrounds an ink passage, patterning the substrate having the passage forming layer by photolithography at least twice to form a sacrificial layer having a planarized top surface in a space surrounded by the passage forming layer, applying a second crosslinked polymer resist composition comprising a phenolic novolak resin precursor polymer having glycidyl ether functional groups on repeating monomer units thereof to the passage forming layer and the sacrificial layer, patterning the second crosslinked polymer resist composition to form a nozzle layer having a nozzle, and removing the sacrificial layer.

The foregoing and/or other aspects and utilities of the present general inventive concept may also be achieved by providing a method of making an inkjet print head, including applying a crosslinkable polymer resist composition comprising a phenolic novolak resin precursor polymer having glycidyl ether functional groups on repeating monomer units thereof to a substrate, exposing the crosslinkable polymer resist composition applied to the substrate to ultraviolet light to form a first crosslinked polymer, developing the first crosslinked polymer, applying a positive photoresist composition to the substrate and the first crosslinked polymer, exposing the positive photoresist composition applied to the substrate and the first crosslinked polymer to ultraviolet light to form a first sacrificial layer, developing the first sacrificial layer, applying the positive photoresist composition to the substrate and the first crosslinked polymer and the first sacrificial layer, exposing the positive photoresist composition applied to the substrate and the first crosslinked polymer and the first sacrificial layer to ultraviolet light to form a second sacrificial layer having a planarized top surface, and developing the second sacrificial layer.

The exposing of the crosslinkable polymer resist composition applied to the substrate may include exposing the crosslinkable polymer resist composition through a first photomask having a passage forming layer pattern thereon to ultraviolet light to form the first crosslinked polymer. The exposing of the positive photoresist composition applied to the substrate and the first crosslinked polymer may include exposing the positive photoresist composition through a second photomask having an ink chamber pattern thereon to ultraviolet light to form the first sacrificial layer. The exposing of the positive photoresist composition applied to the substrate and the first crosslinked polymer and the first sacrificial layer may include exposing the positive photoresist composition through a second photomask having an ink chamber pattern thereon to ultraviolet light to form the second sacrificial layer having a planarized top surface.

The method may further include repeatedly blank exposing the second sacrificial layer having the planarized top surface until a height of the second sacrificial layer is substantially equal to a height of the passage forming layer, developing the blank exposed second sacrificial layer, applying the crosslinkable polymer resist composition to the substrate and the second sacrificial layer, exposing the crosslinkable polymer resist composition applied to the substrate and the second sacrificial layer to ultraviolet light to form a second crosslinked polymer, and developing the second crosslinked polymer. The exposing of the crosslinkable polymer resist composition applied to the substrate and the second sacrificial layer may include exposing the crosslinkable polymer resist composition through a third photomask having nozzle layer pattern thereon to ultraviolet light to form the second crosslinked polymer. The method may further include applying the crosslinkable polymer resist composition to the substrate and the second sacrificial layer, exposing the crosslinkable polymer resist composition applied to the substrate and the second sacrificial layer to ultraviolet light to form a second crosslinked polymer, and developing the second crosslinked polymer, in which the positive photoresist composition is an imide-based positive photoresist composition. The exposing of the crosslinkable polymer resist composition applied to the substrate and the second sacrificial layer can include exposing the crosslinkable polymer resist composition through a third photomask having nozzle layer pattern thereon to ultraviolet light to form the second crosslinked polymer.

The foregoing and/or other aspects and utilities of the present general inventive concept may also be achieved by providing a photolithography method, including applying a first negative photoresist composition to a substrate having a heater and an electrode formed thereon, patterning the negative photoresist composition to form a passage forming layer, applying a positive photoresist composition to a location on the substrate surrounded by the passage forming layer, patterning the positive photoresist composition to form a sacrificial layer, applying a second negative photoresist composition comprising a phenolic novolak resin precursor polymer having glycidyl ether functional groups on repeating monomer units thereof to the passage forming layer and the sacrificial layer, patterning the second negative photoresist composition to form a nozzle having a nozzle layer, and removing the sacrificial layer. The first negative photoresist composition may include a phenolic novolak resin precursor polymer having glycidyl ether functional groups on repeating monomer units thereof. The positive photoresist composition can be an imide-based positive photoresist composition.

The foregoing and/or other aspects and utilities of the present general inventive concept may also be achieved by providing an inkjet print head, including a substrate having at least one heater and at least one electrode and having an ink passage, a passage forming layer located on the substrate defining an ink chamber, and a nozzle layer comprising a crosslinked phenolic novolak resin precursor polymer having glycidyl ether functional groups on repeating monomer units thereof located on the passage forming layer.

A height of the ink chamber can be substantially equal to a height of the passage forming layer. A height of the ink chamber can be greater than a height of the passage forming layer. The passage forming layer can include a crosslinked phenolic novolak resin precursor polymer having glycidyl ether functional groups on repeating monomer units thereof.

The foregoing and/or other aspects and utilities of the present general inventive concept may also be achieved by providing an inkjet print head intermediate useable to make an inkjet print head, including a substrate having at least one heater and at least one electrode and having an ink passage, and a first crosslinked polymer resist layer comprising a crosslinked phenolic novolak resin precursor polymer having glycidyl ether functional groups on repeating monomer units thereof.

The foregoing and/or other aspects and utilities of the present general inventive concept may also be achieved by providing an inkjet print head intermediate useable to make an inkjet print head, including a substrate having at least one heater and at least one electrode and having an ink passage, a passage forming layer located on the substrate defining an ink chamber, and a sacrificial layer having a planarized top surface located on a portion of the substrate substantially surrounded by the passage forming layer.

The passage forming layer can include a crosslinked phenolic novolak resin precursor polymer having glycidyl ether functional groups on repeating monomer units thereof. The sacrificial layer can include an imide-based positive photoresist composition. A height of the sacrificial layer can be substantially equal to a height of the passage forming layer. A height of the sacrificial layer can be greater than a height of the passage forming layer. The inkjet print head intermediate can further include a polymer layer comprising a phenolic novolak resin precursor polymer having glycidyl ether functional groups on repeating monomer units thereof located on the sacrificial layer.

The foregoing and/or other aspects and utilities of the present general inventive concept may also be achieved by providing an inkjet print head, including a substrate having a passage, at least one heater formed on a first portion of the substrate, at least one electrode formed on a second portion of the substrate, a passage forming layer formed on a third portion of the substrate, and a nozzle layer formed on the passage forming layer, having a planarized surface facing the substrate. The surface of the nozzle layer and a surface of the passage forming layer can form an angle without a cavity on at least one of the surfaces of the nozzle layer and the passage forming layer.

The foregoing and/or other aspects and utilities of the present general inventive concept may also be achieved by providing a method of manufacturing an inkjet print head, including forming a substrate having a passage, forming at least one heater on a first portion of the substrate, forming at least one electrode on a second portion of the substrate, forming a passage forming layer on a third portion of the substrate, and forming a nozzle layer having a planarized surface facing the substrate on the passage forming layer. The forming of the nozzle layer having the planarized surface facing the substrate on the passage forming layer can include forming an angle without a cavity between the surface of the nozzle layer and a surface of the passage forming layer.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a schematic perspective view illustrating a structure of a conventional thermally-driven inkjet printhead;

FIGS. 2A through 2E are cross-sectional views illustrating a method of manufacturing the conventional inkjet printhead illustrated in FIG. 1;

FIGS. 3A through 3R are cross-sectional views illustrating a method of manufacturing an inkjet printhead according to an embodiment of the present general inventive concept;

FIGS. 4A through 4F are cross-sectional views illustrating a method of manufacturing inkjet printhead according to an embodiment of the present general inventive concept; and

FIG. 5A is a vertical cross-sectional view of an inkjet printhead according to an embodiment of the present general inventive concept, and FIG. 5B is an enlarged view illustrating the vertical cross-sectional view in FIG. 5A.

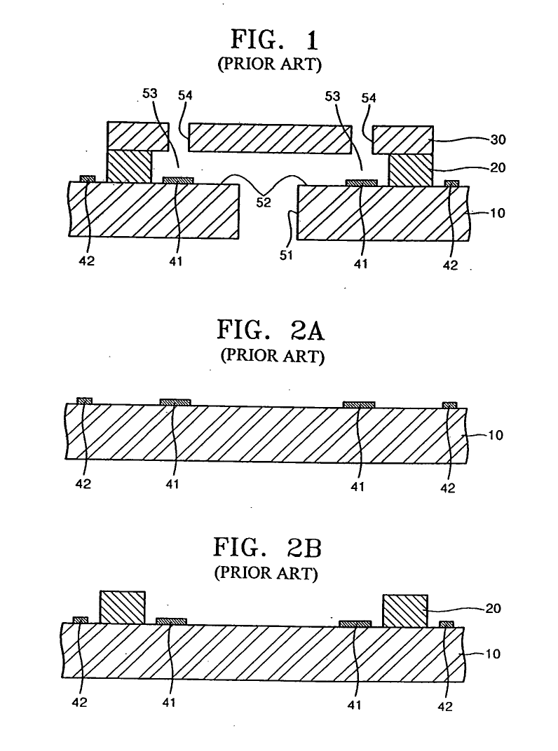

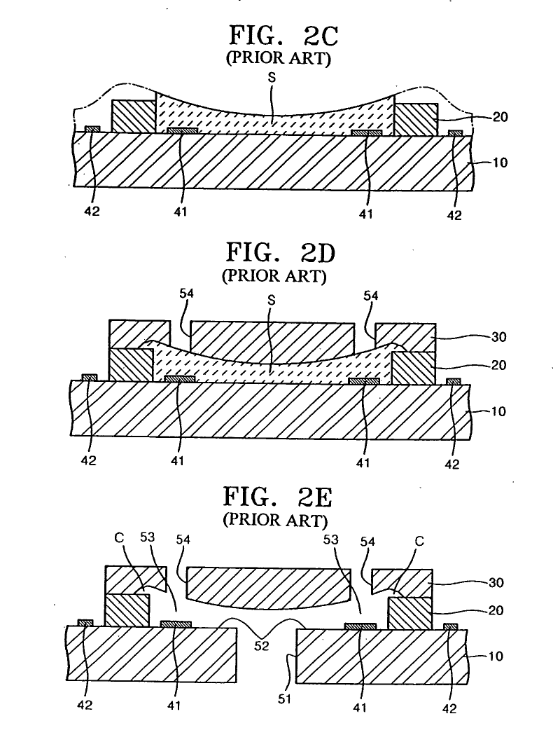

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The present general concept relates to a method of manufacturing an inkjet print head using a crosslinked polymer resist composition. In embodiments, the crosslinked polymer resist composition may include a precursor polymer, a cationic photoinitiator, and a solvent. Furthermore, in embodiments, the crosslinked polymer resist composition may include a crosslinked polymer prepared by exposing a precursor polymer to an actinic radiation.

The precursor polymer may be prepared from a backbone monomer unit selected from the group consisting of phenol, o-cresol, ρ-cresol, bisphenol-A, an alicyclic compound, and mixtures thereof.

The precursor polymer may include repeating monomers, each monomer having one of the following Formulas 1-6:

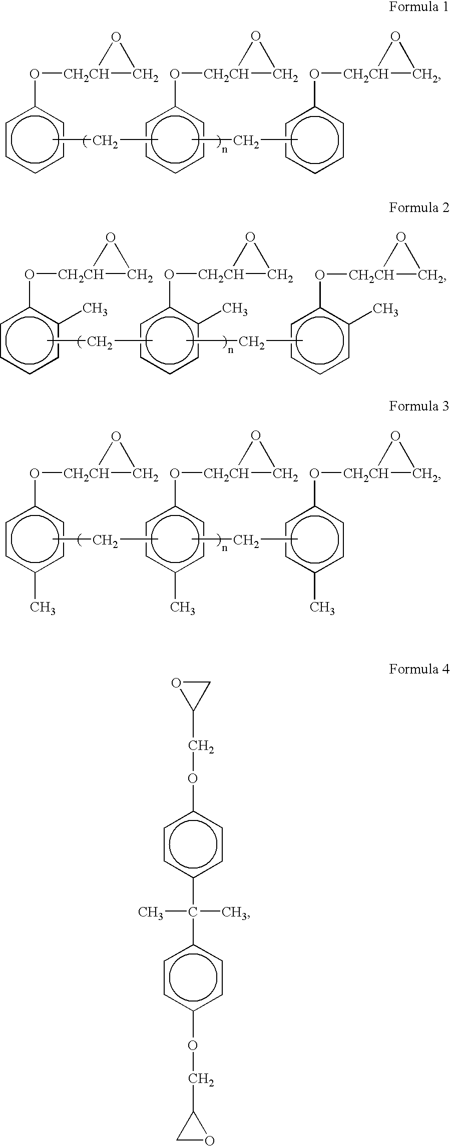

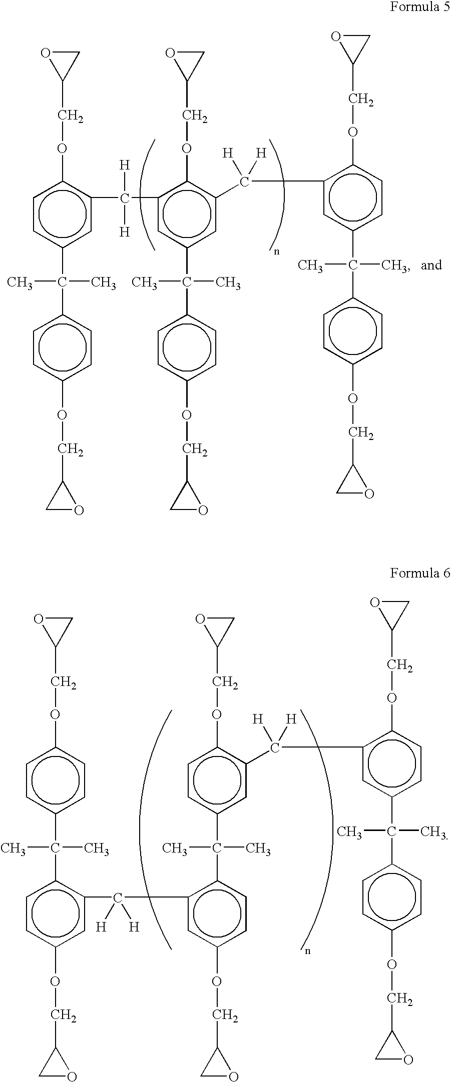

In each of the above structural Formulas 1-6, n is an integer ranging from 1 to about 20. The monomers in the precursor polymer may all have the same formula, may all have different formulas, or may have a mixture of some monomers having the same formula and other monomers having different formulas.

The cationic photoinitiator can be, for example, a sulfonium salt or an iodine salt.

The solvent may be at least one compound selected from the group consisting of α-butyrolactone, propylene glycol methyl ether acetate (PGMEA), tetrahydrofuran (THF), methyl ethyl ketone, methy isobutyl ketone, cyclopentanone, and mixtures thereof.

According to an embodiment of the present general inventive concept, an inkjet printhead can be manufactured by a method including applying a first crosslinked polymer resist composition to a substrate having a heater and an electrode and patterning the first crosslinked polymer resist composition to form a passage forming layer that surrounds an ink passage, patterning the substrate having the passage forming layer by photolithography at least twice, forming a sacrificial layer having a planarized top surface in a space surrounded by the passage forming layer, applying a second crosslinked polymer resist composition to the passage forming layer and the sacrificial layer and patterning the second crosslinked polymer resist composition to form a nozzle layer having a nozzle, and removing the sacrificial layer.

In embodiments, a step difference between the chamber layer of the inkjet printhead and the sacrificial layer is not greater than about 3 μm.

The second crosslinked polymer forming the chamber layer and the nozzle layer can be prepared by crosslinking a precursor polymer that is a phenolic novolak resin having glycidyl ether functional groups on repeating monomer units thereof. The glycidyl ether functional groups can be disposed on hydrogen positions of phenol hydroxide groups. The first crosslinked polymer forming the ink passage layer may also be prepared by crosslinking the precursor polymer that is the phenolic novolak resin having glycidyl ether functional groups on repeating monomer units thereof.

The first and/or the second crosslinked polymer may include an epoxy resin having a difunctional ether group, such as the compounds listed below:

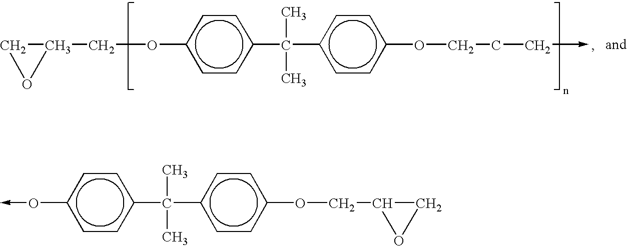

The epoxy resin having a difunctional ether group is able to form a film with a low crosslinking density.

The content of the epoxy resin having a difunctional ether group may range from about 5 to about 50% by weight, based on a total weight of a composition for forming the crosslinked polymer (i.e., the composition before crosslinking). For example, the content of the epoxy resin having a difunctional ether group may range from about 10 to about 20% by weight, based on the total weight of the composition for forming the crosslinked polymer.

Examples of the epoxy resin having the difunctional ether group include, but are not limited to, EPON 828, EPON 1004, EPON 1001F, and EPON 1010 (which are commercially obtainable from Shell Chemicals), DER-332, DER-331, and DER-164 (which are commercially obtainable from Dow Chemical Company), and ERL-4201 and ERL-4289 (which are commercially obtainable from Union Carbide Corporation).

The first and/or the second crosslinked polymer may include an epoxy resin having a multifunctional ether group.

The epoxy resin having a multifunctional ether group is able to form a film with a high crosslinking density, increasing a resolution and thereby preventing swelling with respect to ink or a solvent. The content of the epoxy resin having a multifunctional ether group may range from about 0.5 to about 20% by weight, based on the total weight of the composition for forming the crosslinked polymer. For example, content of the epoxy resin having a multifunctional ether group may range from about 1 to about 5% by weight, based on the total weight of the composition for forming the crosslinked polymer.

Examples of the epoxy resin having the multifunctional ether group include, but are not limited to, EPON SU-8 (which is commercially obtainable from Shell Chemicals), DEN-431 and DEN-439 (which are commercially obtainable from Dow Chemical Company), and EHPE-3150 (which is commercially obtainable from Daicel Chemical Industries, Ltd.).

Examples of suitable backbone monomers for the phenolic novolak resin include phenol. The resulting glycidyl ether functionalized phenolic novolak resin includes compounds of the following Formula 1:

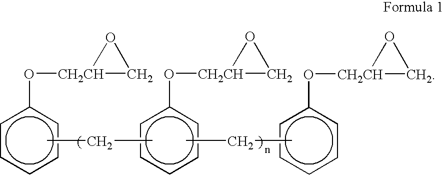

The number n of repeating monomer units in Formula 1 can range from 1 to about 20. For example, the number n of repeating monomer units in Formula 1 can range from 1 to about 10.

Other examples of suitable backbone monomers for the phenolic novolak resin include o-cresol or p-cresol including branched structures of phenol. The resulting glycidyl ether functionalized phenolic novolak resin includes compounds of the following Formulas 2 and 3:

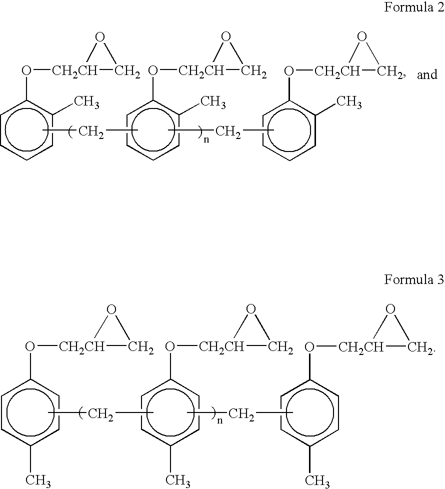

The number n of repeating monomer units in Formulas 2 and 3 can range from 1 to about 20. For example, the number n of repeating monomer units in Formulas 2 and 3 can range from 1 to about 10.

Further, examples of suitable backbone monomers for the phenolic novolak resin include bisphenol A. The resulting glycidyl ether functionalized phenolic novolak resin includes compounds of the following Formulas 5 and 6.

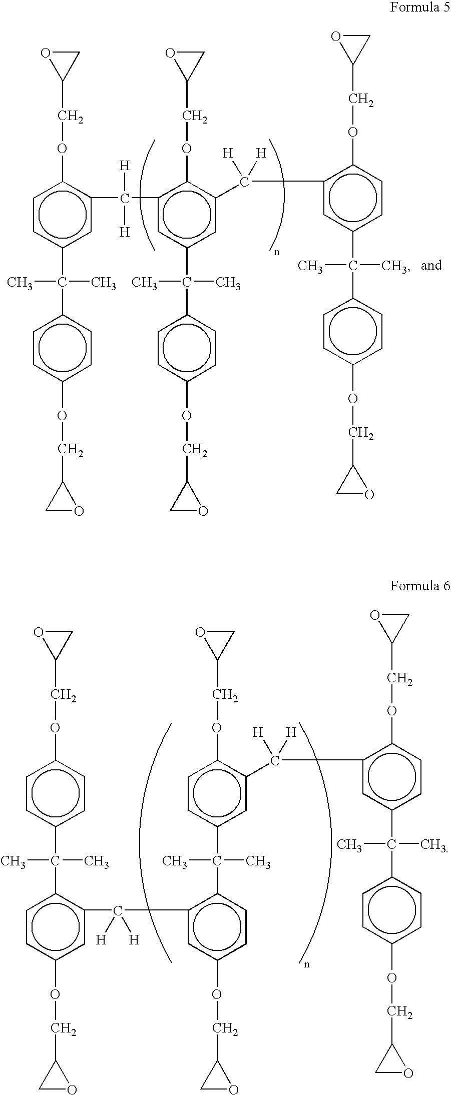

The number n of repeating monomer units in Formulas 5 and 6 can range from 1 to about 20. For example, the number n of repeating monomer units in Formulas 5 and 6 can range from 1 to about 10.

The first and/or the second crosslinked polymer may further include one or more photoinitiators. Photoinitiators are compounds that can generate ions or free radicals that initiate polymerization upon exposure to light. The content of the photoinitiator may range from about 1.0 to about 10% by weight, based on a total weight of the crosslinked polymer composition. For example, the content of the photoinitiator may range from about 1.5 to about 5% by weight, based on the total weight of the crosslinked polymer composition.

Examples of suitable photoinitiators include, but are not limited to, aromatic halominum salts and aromatic onium salts of Group VA or VI elements. For example, suitable photoinitiators include, but are not limited to, UVI-6974 (which is commercially obtainable from Union Carbide Corporation), SP-172 (which is commercially obtainable from Asahi denka, Co., Ltd.), and on the like.

Specific examples of the aromatic sulfonium salt include, but are not limited to, tetrafluoroborate triphenylsulfonium, tetrafluoroborate methyl diphenylsulfonium, hexafluorophosphate dimethyl phenylsulfonium, hexafluorophosphate triphenylsulfonium, hexafluoroantimonate triphenylsulfonium, hexafluoroantimonate phenylmethyl benzyl sulfonium, and on the like.

Specific examples of the aromatic iodonium salt include, but are not limited to, tetrafluoroborate diphenyl iodonium, hexafluoroantimonate diphenyl iodonium, hexafluoroantimonate butylphenyl iodonium, and on the like.

The first and/or the second crosslinked polymer may further include a solvent. Examples of suitable solvents include, but are not limited to, α-butyrolactone, propylene glycol methyl ether acetate (PGMEA), tetrahydrofuran (THF), methyl ethyl ketone, methy isobutyl ketone, cyclopentanone, and mixtures thereof.

A suitable content of the solvent can range from about 20 to about 90% by weight based on the total weight of the crosslinked composition. For example, the content of the solvent can range from about 45 to about 75% by weight, based on the total weight of the crosslinked composition.

As additional additives, photosensitizers, silane coupling agents, fillers, viscosity modifiers, and the like, can be used in the first and/or the second crosslinked polymer.

Sensitizers absorb light energy and facilitates the transfer of energy to another compound, which can then form radical or ionic initiators. Sensitizers frequently expand a useful energy wavelength range for photoexposure, and typically are aromatic light absorbing chromophores. Sensitizers can also lead to the formation of photoinitiators, which can be free radical or ionic forms. Thus, the first and/or the second crosslinked polymer may further include one or more sensitizers in addition to, or instead of, the one or more photoinitiators. When present, the sensitizer can be present in an amount of from about 0.1 to about 20 percent by weight based on the total weight of the crosslinked composition.

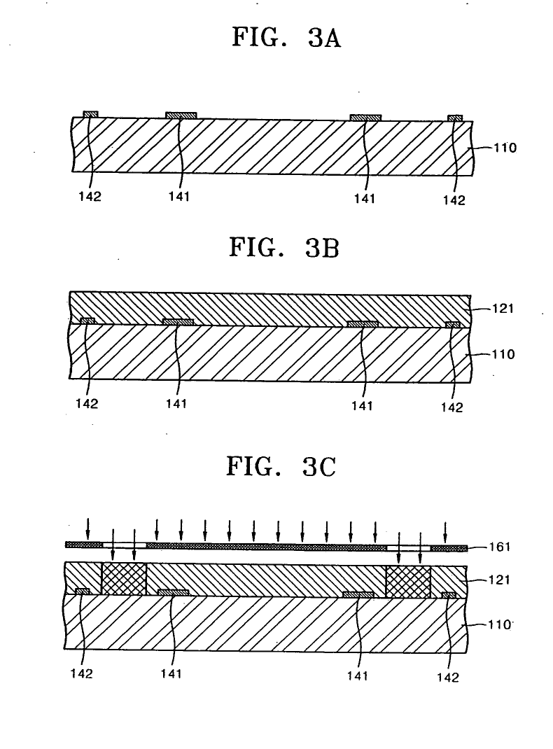

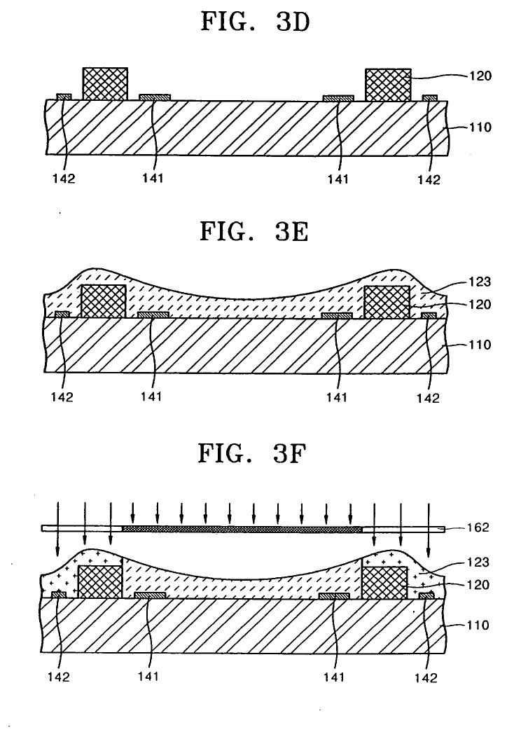

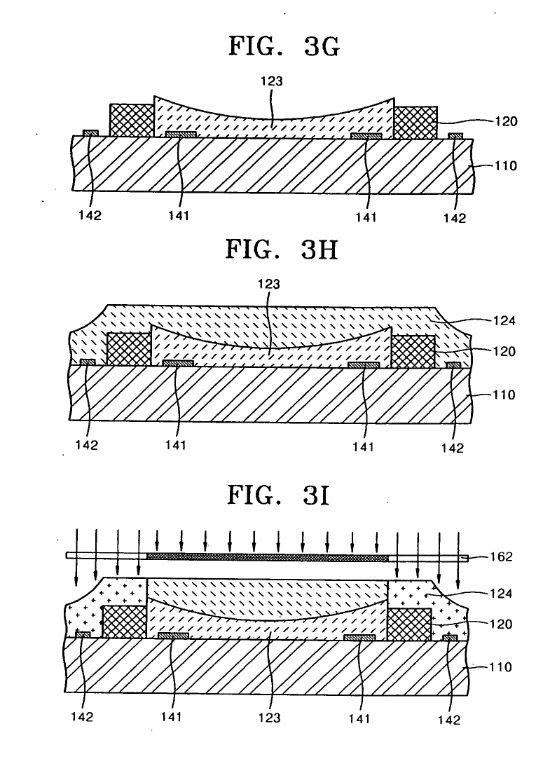

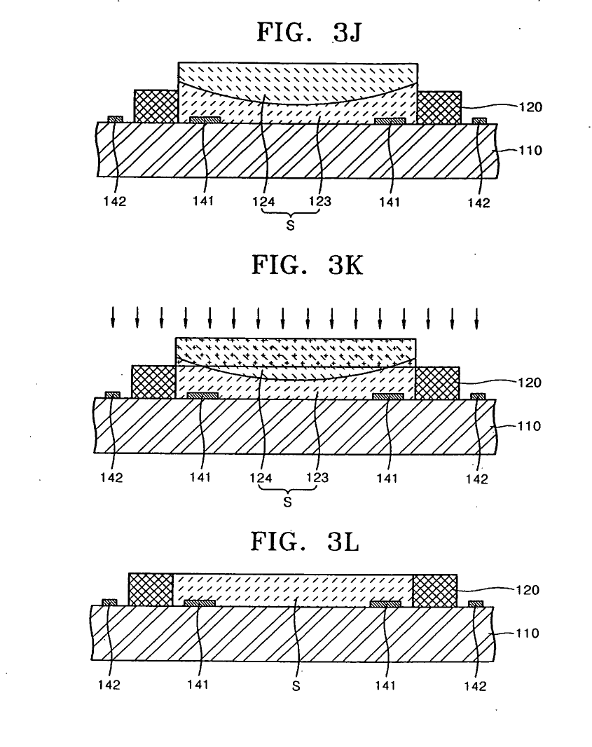

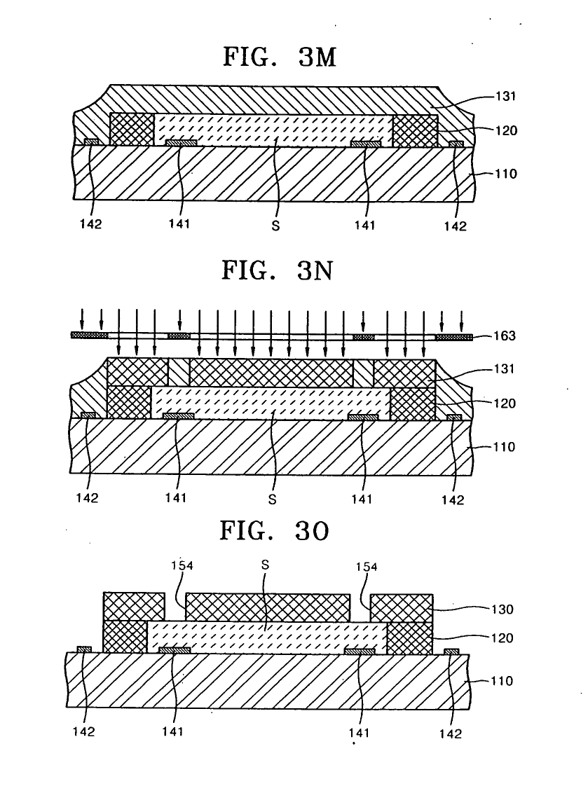

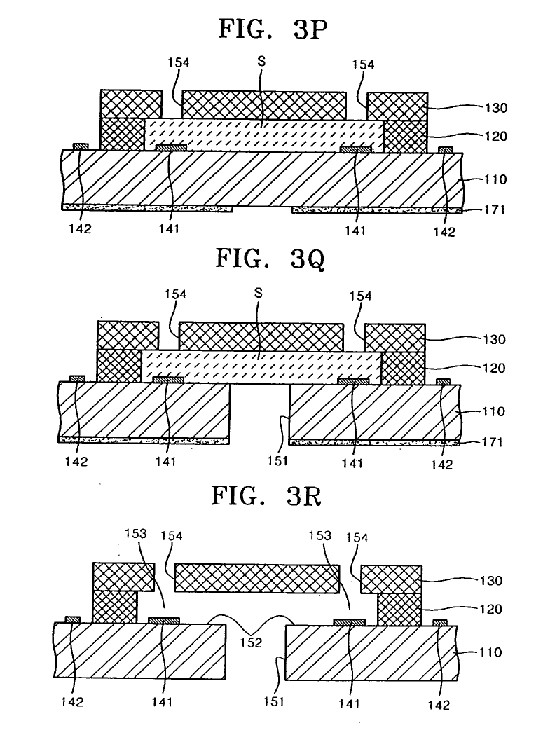

FIGS. 3A through 3R are cross-sectional views illustrating a method of manufacturing an inkjet printhead according to an embodiment of the present general inventive concept, in which a precursor polymer that is a phenolic novolak resin having glycidyl ether functional groups on repeating monomer units thereof is crosslinked.

As illustrated in FIG. 3A, a heater 141 to heat ink and an electrode 142 to supply current to the heater 141 can be formed on a substrate 110.

A silicon wafer is used as the substrate 110 in FIGS. 3A-3R. A silicon wafer is widely used in manufacturing semiconductor devices and is advantageous for mass production. However, the present general inventive concept is not limited to the substrate 110 being a silicon wafer.

The heater 141 can be formed by depositing a resistive heating element, such as tantalum-nitride or a tantalum-aluminium alloy, on the substrate 110 by sputtering or chemical vapor deposition (CVD) and patterning the deposited resistive heating element. The electrode 142 can be formed by depositing a metal having good conductivity, such as aluminum or an aluminum alloy, on the substrate 110 by sputtering and patterning the deposited metal. Although not illustrated, a passivation layer made of, for example, silicon oxide or silicon nitride, may be formed on the heater 141 and the electrode 142.

As illustrated in FIG. 3B, a first crosslinked polymer resist layer 121 can be formed on the substrate 110 where the heater 141 and the electrode 142 are formed. Since the first crosslinked polymer resist layer 121 forms an ink chamber 153 (see FIG. 3R) and an ink passage surrounding a restrictor 152 (see FIG. 3R), which will later be described, the first crosslinked polymer resist layer 121 is formed of a negative-type resist compound that is chemically stable against ink. In particular, the first crosslinked polymer resist layer 121 can be formed by applying a crosslinkable polymer resist composition to a predetermined thickness to an entire surface of the substrate 110. Here, the crosslinkable polymer resist composition may be applied to a thickness substantially corresponding to a height of the ink chamber so as to accommodate the quantity of ink droplets ejected. The crosslinkable polymer resist composition may be applied to the substrate 110 by spin coating.

As illustrated in FIG. 3C, the first crosslinkable polymer resist composition made of the negative-type crosslinked polymer resist can be exposed to an actinic radiation, such as ultraviolet (UV) light, using a first photomask 161 having a passage forming layer pattern. Specifically, an exposed portion of the first crosslinkable polymer resist composition can be crosslinked and hardened so as to have chemical resistance and high mechanical strength, thereby forming the first crosslinked polymer resist layer 121. On the other hand, an unexposed portion of the first crosslinkable polymer resist is easily dissolved in a developer.

Then, the first crosslinked polymer resist layer 121 can then be developed to remove the unexposed portion, forming a space, and the portion exposed to be hardened remains, forming a passage forming layer 120.

FIGS. 3E through 3L illustrate the formation of a sacrificial layer S in the space surrounded by the passage forming layer 120. The sacrificial layer S has a planarized top surface (i.e., the top surface does not protrude at its peripheral edges, and does not bulge upward around the passage forming layer 122). According to various embodiments of the present general inventive concept, the top surface of the sacrifical layer S can be planarized by applying a positive-type photoresist, patterning the positive-type photoresist at least twice, and planarizing the resulting structure once.

In more detail, as illustrated in FIG. 3E, the positive-type photoresist can be applied to the entire surface of the substrate 110 having the passage forming layer 120 to a predetermined thickness by spin-coating, thereby forming a first sacrificial layer 123. Here, the positive-type photoresist bulges upward due to the protruding passage forming layer 120, making the top surface of the first sacrificial layer 123 uneven. As illustrated in FIG. 3F, the positive-type photoresist can be exposed to ultraviolet (UV) light using a second photomask 162 having an ink chamber and a restrictor pattern to form the first sacrificial layer 123. Specifically, a portion of the positive-type photoresist exposed to UV becomes easily dissolved in a developer. Thus, when the first sacrificial layer 123 is developed, only an unexposed portion of the positive-type photoresist remains as the first sacrificial layer 123 while the exposed portion is removed, as illustrated in FIG. 3G.

As illustrated in FIG. 3H, the positive-type photoresist is applied for a second time to the entire surface of the substrate 110 having the passage forming layer 120 and the first sacrificial layer 123 to a predetermined thickness by spin-coating, thereby forming a second sacrificial layer 124. The top surface of the first sacrificial layer 123 can be planarized by the second sacrificial layer 124 filling the space surrounded by the passage forming layer 120.

As illustrated in FIG. 31, the twice-applied positive-type photoresist can be exposed to UV light using a second photomask 162, which is identical to the first photomask 161 used to expose the first sacrificial layer 123, to form the second sacrificial layer 124. Subsequently, the second sacrificial layer 124 can be developed to remove an unexposed portion of the second sacrificial layer 124. Then, as illustrated in FIG. 3J, the sacrificial layer S consisting of the first sacrificial layer 123 and the second sacrificial layer 124 and having the planarized top surface can be formed in a space surrounded by the passage forming layer 120.

As illustrated in FIG. 3K, the sacrificial layer S can then be exposed to UV light. Here, the exposing may be performed by blank exposure without using a photomask. The sacrificial layer S can be continuously exposed so that the top surface of the sacrificial layer S becomes substantially the same height as that of the passage forming layer 120 by controlling an exposure time and light intensity. Next, the exposed sacrificial layer S can be developed to remove the exposed portion of the sacrificial layer S and to lower the height of the sacrificial layer S, so that the sacrificial layer S has substantially the same height as the passage forming layer 120, as illustrated in FIG. 3L.

While the foregoing description has described that the sacrificial layer S can be formed by applying, exposing, and developing the first sacrificial layer 123 (see FIGS. 3E-3G), applying, exposing, and developing the second sacrificial layer 124 (see FIGS. 3H-3J), and then performing blank exposure and development (see FIGS. 3K-3L), the sacrificial layer S may be formed differently from the above-described formation. For example, after applying, exposing, and developing the first sacrificial layer 123 (see FIGS. 3E-3G), the application of the second sacrificial layer 124 may be followed by performing blank exposure (as opposed to the exposure through the second photomask 162 illustrated in FIG. 31). Subsequently, development can be performed to allow the second sacrificial layer 124 and the first sacrificial layer 123 to remain as high as the passage forming layer 120. Next, the same exposure using the second photomask 162 and development steps can be performed, leaving only the sacrificial layer S surrounded by the passage forming layer 120.

Alternatively, the sacrificial layer S may be formed as described below. After applying, exposing, and developing the first sacrificial layer 123 (see FIGS. 3E-3G), the second sacrificial layer 124 can be applied and exposed using the second photomask 162 and using blank exposure. Here, the sequence of exposing using the second photomask 162 and using blank exposure may be reversed. That is, the applied second sacrificial layer 124 can be exposed using blank exposure followed by exposure using the second photomask 162. Subsequently, the exposed portion is removed by development, so that only the sacrificial layer S surrounded by the passage forming layer 120 remains.

While the foregoing description has described that the positive-type photoresist is applied twice in order to form a sacrificial layer S having a planarized top surface, the positive-type photoresist may be applied three or more times until the sacrificial layer S has a desired thickness. In this case, the number of times of performing exposure and development increases according to the number of times of applying positive-type photoresist.

Next, as illustrated in FIG. 3M, a second crosslinked polymer layer 131 can be formed on the substrate 110 where the passage forming layer 120 and the sacrificial layer S are formed. Since the second crosslinked polymer layer 131 forms a nozzle layer 130 (see FIG. 30), which will later be described, second crosslinked polymer layer 131 can be formed of a negative-type composition that is chemically stable against ink, like the passage forming layer 120. In particular, the second crosslinked polymer layer 131 can be formed by applying a crosslinkable polymer resist composition to an entire surface of the substrate 110 to a predetermined thickness by spin coating. Here, the crosslinkable polymer resist composition may be applied to a thickness enough to obtain a sufficiently long nozzle and to withstand a change in the pressure of the ink chamber upon formation of the second crosslinked polymer layer 131.

Since the sacrificial layer S is formed to have substantially the same height as the passage forming layer 120, that is, the top surface of the sacrificial layer S is planarized, it is possible to overcome the deformation or melting problem that occurs in the prior art, as discussed above. In particular, the deformation or melting of edges of the sacrificial layer S due to a reaction between the positive-type photoresist forming the sacrificial layer S and the crosslinked polymer resist composition forming the second crosslinked polymer layer 131 that occurs in the prior art is avoided. Thus, the second crosslinked polymer layer 131 can be suitably adhered to the passage forming layer 120.

FIGS. 5A and 5B are vertical cross-sectional views illustrating inkjet printheads manufactured according to an embodiment of the present general inventive concept. Referring to FIGS. 5A and 5B, a cavity is not formed between a passage forming layer 120 and a nozzle layer 130, which suggests that the passage forming layer 120 and the nozzle layer 130 are suitably adhered to each other.

As illustrated in FIG. 3N, the crosslinkable polymer resist is exposed using a third photomask 163 having a nozzle pattern to form the second crosslinked polymer layer 131. Subsequently, the second crosslinked polymer layer 131 is developed, thereby removing an unexposed portion and forming a nozzle 154, while the exposed, hardened portion remains, forming the nozzle layer 130, as illustrated in FIG. 30. Actinic ray radiation can be used to expose the crosslinkable polymer resist. Specifically, a UV beam of not longer than an I-line radiation (353 nm), H-line radiation (405 nm), and G-line radiation (436 nm), or an e-beam or X-ray having wavelengths shorter than an I-line radiation can be used.

As described above, exposing by using light having a relatively short wavelength shortens a transmission length of light, so that the sacrificial layer S disposed under the second crosslinked polymer layer 131 is not affected by exposure. Thus, nitrogen gas is not generated in the sacrificial layer S formed of the positive-type photoresist, thereby avoiding deformation of the nozzle layer 130 due to nitrogen gas.

As illustrated in FIG. 3P, an etch mask 171 to form an ink supply hole 151 (see FIG. 3Q) can be formed on a rear surface of the substrate 110. The etch mask 171 is formed by applying positive- or crosslinked polymer resist to the rear surface of the substrate 110 and patterning the same.

Next, as illustrated in FIG. 3Q, the substrate 110 exposed by the etch mask 171 can be etched from the rear surface thereof to be perforated, thereby forming an ink supply hole 151, followed by removing the etch mask 171. More specifically, the etching of the rear surface of the substrate 110 may be performed by dry etching using, for example, plasma. Alternatively, the rear surface of the substrate 110 may be etched by wet etching using, for example, tetramethyl ammonium hydroxide (TMAH) or KOH as an etchant.

Finally, the sacrificial layer S can be removed using a solvent, thereby forming the ink chamber 153 and the restrictor 152 surrounded by the passage forming layer 120 in a space without the sacrificial layer S, as illustrated in FIG. 3R.

In such a manner, an inkjet printhead having the structure illustrated in FIG. 3R is completed. In embodiments, a step difference between the ink chamber layer 153 of the inkjet printhead and the sacrificial layer S is not greater than 3 μm.

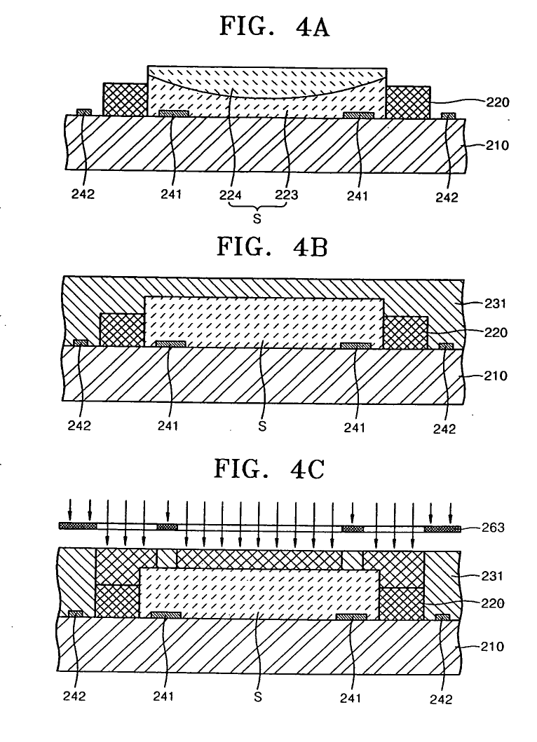

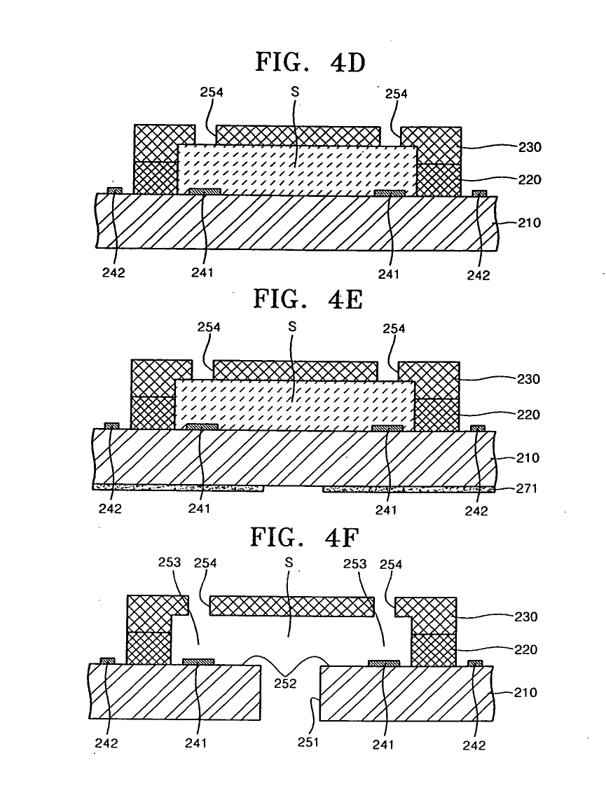

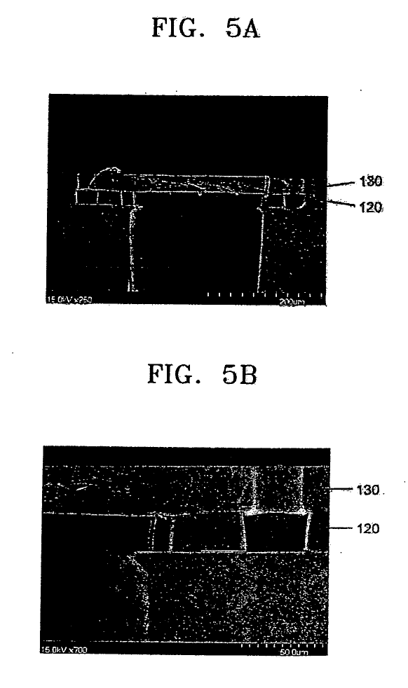

FIGS. 4A through 4F are cross-sectional views illustrating a method of manufacturing an inkjet printhead according to an embodiment of the present general inventive concept. In the following description, the same portions as those described above with respect to the embodiment illustrated in FIGS. 3A-3N will be briefly described or omitted for the sake of brevity.

A sacrificial layer S is formed on a substrate 210 in substantially the same manner as illustrated in FIGS. 3A through 3J, which will now be described briefly. As illustrated in FIG. 4A, the substrate 210 is prepared and a heater 241 to heat ink and an electrode 242 to supply current to the heater 241 are formed on the substrate 210. Next, a crosslinkable polymer resist composition is applied to the substrate 210 having the heater 241 and the electrode 242 to a predetermined thickness, followed by exposing and developing the crosslinkable polymer resist composition, thereby forming a passage forming layer 220. Here, the passage forming layer 220 may be formed to be slightly lower than an ink chamber having a desired height. Then, a positive-type photoresist composition is applied to an entire surface of the substrate 210 having the passage forming layer 220 to a predetermined thickness by spin-coating, thereby forming a first sacrificial layer 223, and the applied positive-type photoresist composition is exposed and developed. Subsequently, the positive-type photoresist composition is applied a second time to the entire surface of the substrate 210 to a predetermined thickness by spin-coating, thereby forming a second sacrificial layer 224, and the twice applied positive-type photoresist composition is exposed and developed. In such a manner, the sacrificial layer S having the first and second sacrificial layers 223 and 224 and having a planarized top surface is formed in a space surrounded by the passage forming layer 220, as illustrated in FIG. 4A.

When forming the sacrificial layer S, an imide-based positive-type photoresist can be used as the positive-type photoresist, and blank exposure and development therefore do not need to be performed. In other words, if the imide-based positive-type photoresist is used as the positive-type photoresist, the height of the sacrificial layer S does not need to be made substantially equal to that of the passage forming layer 220. The imide-based positive-type photoresist should be subjected to hard baking at approximately 140° C. after being developed. However, the imide-based positive-type photoresist is not affected by a solvent contained in the crosslinked polymer resist composition and does not result in the generation of nitrogen gas even upon exposure, which will later be described in more detail.

As illustrated in FIG. 4B, a second crosslinked polymer layer 231 is formed on the substrate 210 having the passage forming layer 220 and the sacrificial layer S. Since the second crosslinked polymer layer 231 forms a nozzle layer 230 (see FIG. 4D), which will later be described, the second crosslinked polymer layer 231 is formed of a negative-type composition that is chemically stable against ink. The second crosslinked polymer layer 231 can be formed as described above for the second crosslinked polymer layer 131.

As illustrated in FIGS. 4A and 4B, the sacrificial layer S can be formed to protrude higher than the passage forming layer 220. However, since the sacrificial layer S is formed of the imide-based positive-type photoresist, it is not affected by a solvent contained in the crosslinkable polymer resist composition forming the second crosslinked polymer layer 231, as described above. Thus, unlike in the prior art, the deformation or melting problem occurring at edges of the sacrificial layer S can be avoided.

Next, as illustrated in FIG. 4C, the second crosslinked polymer layer 231 formed of the crosslinkable polymer resist composition can be exposed using a photomask 263 having a nozzle pattern to form the second crosslinked polymer layer 231. Subsequently, the second crosslinked polymer layer 231 can be developed, thereby removing an unexposed portion and forming a nozzle 254, while the exposed, hardened portion remains, forming the nozzle layer 230, as illustrated in FIG. 4D.

Since the imide-based positive-type photoresist forming the sacrificial layer S does not produce nitrogen gas even upon exposure, the deformation problem of the nozzle layer 230 due to nitrogen gas in the prior art does not occur. Thus, radiation of an actinic ray can be used to expose the crosslinkable polymer resist composition. Specifically, a UV beam over a broadband, including I-line radiation (353 nm), H-line radiation (405 nm), and G-line radiation (436 nm), or e-beam or X-ray having wavelengths shorter than the broadband radiations, may be used.

As illustrated in FIG. 4E, an etch mask 271 can be formed on a rear surface of the substrate 210, and the substrate 210 exposed by the etch mask 271 is etched from the rear surface thereof to be perforated by dry etching or wet etching, thereby forming an ink supply hole 251. Specific steps for forming the etch mask 271 and the ink supply hole 251 are the same as those illustrated in FIGS. 3P-3Q.

Finally, the sacrificial layer S can be removed using a solvent, thereby forming the ink chamber 253 and the restrictor 252 surrounded by the passage forming layer 220 in a space without the sacrificial layer S, as illustrated in FIG. 4F.

In such a manner, an inkjet printhead having the structure illustrated in FIG. 4F is completed. In embodiments, a step difference between the chamber layer of the inkjet printhead and the sacrificial layer is not greater than 3 μm.

### EXAMPLES

Preparation of Resist Composition 1

50 ml xylene (commercially available from Samchun Chemical Co.) and 10 ml SP-172 (commercially available from Asashi Eenka Korea Chemical Co.) were added to a reactor. 90 g of an epoxy resin in the trade name of EHPH-3150 (commercially available from Daicel Chemical Industries. Ltd.) was then added to the reactor, and the resultant solution was stirred for 24 hours.

Preparation of Resist Composition 2

A commercial resist solution of EPON SU-8 was obtained from MicroChem Corp., and was used as received. The commercial solution included y-butyrolactone contained in an amount between 25 and 50 percent by weight, and a mixture of triarylsulfonium hexafluoroantimonate salt and p-thiophenoxyphenyidiphenysulfonium hexafluoroantimonate in propylene carbonate contained in an amount between 1 and 5 percent by weight.

As described above, since a top surface of a sacrificial layer is planarized in methods of manufacturing an inkjet printhead according to various embodiments of the present general inventive concept, it is possible to overcome the deformation or melting problem occurring in the prior art, that is, it is possible to avoid the deformation or melting of edges of the sacrificial layer due to a reaction between a positive-type photoresist composition and a crosslinked polymer resist composition. Thus, a shape and dimension of an ink passage can be easily controlled, thereby improving a uniformity of the ink passage, ultimately improving ink ejection performance of the inkjet printhead. Also, since a passage forming layer and a nozzle layer are suitably adhered to each other, durability of the printhead is enhanced. Further, since nitrogen gas is not generated in the sacrificial layer during photography to form a nozzle, deformation of the nozzle layer due to nitrogen gas can be avoided. Accordingly, uniformity of the ink passage can be further enhanced.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing a monolithic inkjet printhead, the method comprising:
preparing a substrate having a heater to heat ink and an electrode to supply current to the heater;
applying a crosslinkable polymer resist composition to the substrate having the heater and the electrode and patterning the crosslinkable polymer resist composition to form a passage forming layer that surrounds an ink passage;
patterning the substrate having the passage forming layer by photolithography at least twice, and forming a sacrificial layer having a planarized top surface in a space surrounded by the passage forming layer;
applying the crosslinkable polymer resist composition to the passage forming layer and the sacrificial layer and patterning the crosslinkable polymer resist composition to form a nozzle layer having a nozzle;
etching a bottom surface of the substrate to form an ink supply hole; and
removing the sacrificial layer,
wherein the crosslinkable polymer resist composition comprises a precursor polymer that is a phenolic novolak resin having glycidyl ether functional groups on repeating monomer units thereof.

2. The method of claim 1, wherein the crosslinkable polymer resist composition further comprises:
a cationic photoinitiator; and
a solvent.

3. The method of claim 1, wherein the precursor polymer is prepared from a backbone monomer unit selected from the group consisting of phenol, o-cresol, ρ-cresol, bisphenol-A, an alicyclic compound, and mixtures thereof.

4. The method of claim 1, wherein the precursor polymer comprises repeating monomers, each monomer having one of the formulas: 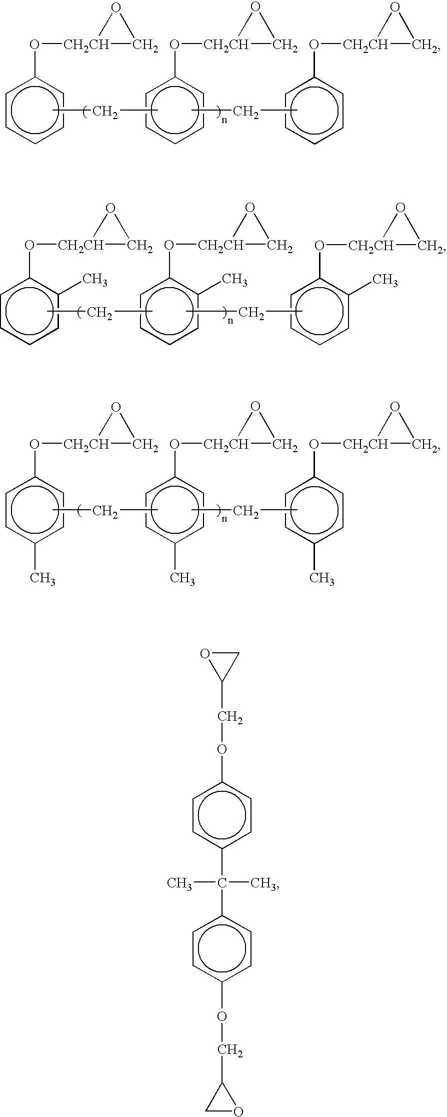 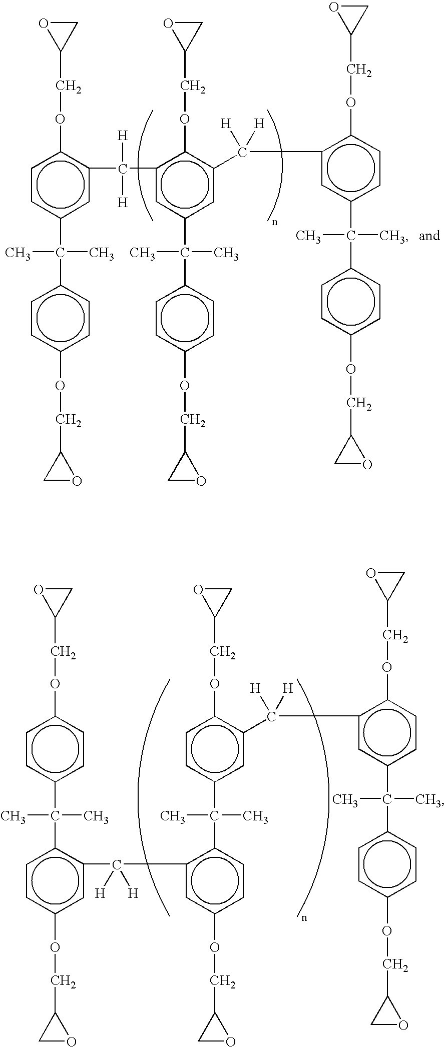
wherein n is an integer ranging from 1 to about 20.

5. The method of claim 1, further comprising crosslinking the crosslinkable polymer resist composition by exposing the precursor polymer to radiation of an actinic ray.

6. The method of claim 2, wherein the cationic photoinitiator is a sulfonium salt or an iodine salt.

7. The method of claim 2, wherein the solvent is at least one compound selected from the group consisting of α-butyrolactone, propylene glycol methyl ether acetate (PGMEA), tetrahydrofuran (THF), methyl ethyl ketone, methy isobutyl ketone, cyclopentanone, and mixtures thereof.

8. An inkjet printhead manufactured according to the method of claim 1.

9. The inkjet printhead of claim 8, wherein a step difference between a chamber layer of the inkjet printhead and the sacrificial layer is not greater than 3 μm.

10. The method of claim 4, wherein the monomers in the precursor polymer all have an identical formula.

11. The method of claim 4, wherein the monomers in the precursor polymer all have different formulas.

12. The method of claim 4, wherein the monomers in the precursor polymer include a mixture of some of the monomers have an identical formula and others of the monomers have different formulas.

13. A method of making an inkjet print head, comprising:
applying a first crosslinked polymer resist composition to a substrate having a heater and an electrode;
patterning the first crosslinked polymer resist composition to form a passage forming layer that surrounds an ink passage;
patterning the substrate having the passage forming layer by photolithography at least twice to form a sacrificial layer having a planarized top surface in a space surrounded by the passage forming layer;
applying a second crosslinked polymer resist composition comprising a phenolic novolak resin precursor polymer having glycidyl ether functional groups on repeating monomer units thereof to the passage forming layer and the sacrificial layer;
patterning the second crosslinked polymer resist composition to form a nozzle layer having a nozzle; and
removing the sacrificial layer.

14. A method of making an inkjet print head, comprising:
applying a crosslinkable polymer resist composition comprising a phenolic novolak resin precursor polymer having glycidyl ether functional groups on repeating monomer units thereof to a substrate;
exposing the crosslinkable polymer resist composition applied to the substrate to ultraviolet light to form a first crosslinked polymer;
developing the first crosslinked polymer;
applying a positive photoresist composition to the substrate and the first crosslinked polymer;
exposing the positive photoresist composition applied to the substrate and the first crosslinked polymer to ultraviolet light to form a first sacrificial layer;
developing the first sacrificial layer;
applying the positive photoresist composition to the substrate and the first crosslinked polymer and the first sacrificial layer;
exposing the positive photoresist composition applied to the substrate and the first crosslinked polymer and the first sacrificial layer to ultraviolet light to form a second sacrificial layer having a planarized top surface; and
developing the second sacrificial layer.

15. The method of claim 14, wherein the exposing of the crosslinkable polymer resist composition applied to the substrate comprises exposing the crosslinkable polymer resist composition through a first photomask having a passage forming layer pattern thereon to ultraviolet light to form the first crosslinked polymer.

16. The method of claim 14, wherein the exposing of the positive photoresist composition applied to the substrate and the first crosslinked polymer comprises exposing the positive photoresist composition through a second photomask having an ink chamber pattern thereon to ultraviolet light to form the first sacrificial layer.

17. The method of claim 14, wherein the exposing of the positive photoresist composition applied to the substrate and the first crosslinked polymer and the first sacrificial layer comprises exposing the positive photoresist composition through a second photomask having an ink chamber pattern thereon to ultraviolet light to form the second sacrificial layer having a planarized top surface.

18. The method of claim 14, further comprising:
repeatedly blank exposing the second sacrificial layer having the planarized top surface until a height of the second sacrificial layer is substantially equal to a height of the passage forming layer;
developing the blank exposed second sacrificial layer;
applying the crosslinkable polymer resist composition to the substrate and the second sacrificial layer;
exposing the crosslinkable polymer resist composition applied to the substrate and the second sacrificial layer to ultraviolet light to form a second crosslinked polymer; and
developing the second crosslinked polymer.

19. The method of claim 18, wherein the exposing of the crosslinkable polymer resist composition applied to the substrate and the second sacrificial layer comprises exposing the crosslinkable polymer resist composition through a third photomask having nozzle layer pattern thereon to ultraviolet light to form the second crosslinked polymer.

20. The method of claim 14, further comprising:
applying the crosslinkable polymer resist composition to the substrate and the second sacrificial layer;
exposing the crosslinkable polymer resist composition applied to the substrate and the second sacrificial layer to ultraviolet light to form a second crosslinked polymer; and
developing the second crosslinked polymer,
wherein the positive photoresist composition is an imide-based positive photoresist composition.

21. The method of claim 20, wherein the exposing of the crosslinkable polymer resist composition applied to the substrate and the second sacrificial layer comprises exposing the crosslinkable polymer resist composition through a third photomask having nozzle layer pattern thereon to ultraviolet light to form the second crosslinked polymer.

22. An inkjet print head, comprising:
a substrate having at least one heater and at least one electrode and having an ink passage;
a passage forming layer located on the substrate defining an ink chamber; and
a nozzle layer comprising a crosslinked phenolic novolak resin precursor polymer having glycidyl ether functional groups on repeating monomer units thereof located on the passage forming layer.

23. The inkjet print head of claim 22, wherein a height of the ink chamber is substantially equal to a height of the passage forming layer.

24. The inkjet print head of claim 22, wherein a height of the ink chamber is greater than a height of the passage forming layer.

25. The inkjet print head of claim 22, wherein the passage forming layer comprises a crosslinked phenolic novolak resin precursor polymer having glycidyl ether functional groups on repeating monomer units thereof.

26. An inkjet print head intermediate useable to make an inkjet print head, comprising:
a substrate having at least one heater and at least one electrode and having an ink passage; and
a first crosslinked polymer resist layer comprising a crosslinked phenolic novolak resin precursor polymer having glycidyl ether functional groups on repeating monomer units thereof.

27. An inkjet print head intermediate useable to make an inkjet print head, comprising:
a substrate having at least one heater and at least one electrode and having an ink passage;
a passage forming layer located on the substrate defining an ink chamber; and
a sacrificial layer having a planarized top surface located on a portion of the substrate substantially surrounded by the passage forming layer.

28. The inkjet print head intermediate of claim 27, wherein the passage forming layer comprises a crosslinked phenolic novolak resin precursor polymer having glycidyl ether functional groups on repeating monomer units thereof.

29. The inkjet print head intermediate of claim 27, wherein the sacrificial layer comprises an imide-based positive photoresist composition.

30. The inkjet print head intermediate of claim 27, wherein a height of the sacrificial layer is substantially equal to a height of the passage forming layer.

31. The inkjet print head intermediate of claim 27, wherein a height of the sacrificial layer is greater than a height of the passage forming layer.

32. The inkjet print head intermediate of claim 27, further comprising a polymer layer comprising a phenolic novolak resin precursor polymer having glycidyl ether functional groups on repeating monomer units thereof located on the sacrificial layer.
